(19) United States
(12) Patent Application Publication
(10) Pub. No.: US 2011/0181409 A1
(43) Pub. Date: Jul. 28, 2011

(54) INTERCHANGEABLE COMMUNICATION DEVICE

(76) Inventor: Chastie Samms, Davenport, FL (US)

(21) Appl. No.: 12/695,335

(22) Filed: Jan. 28, 2010

(51) Int. Cl. G08B 1/08; H04B 7/00

(52) U.S. Cl. 340/539.13; 340/539.11; 455/41.3

(57) ABSTRACT

An interchangeable personal storage and communication device can include a main body having a memory for storing data, a communication unit for communicating with at least one external device, and a display. The device may further include a host apparatus that can be worn on or about a user into which the main body can be removably connected.

### BACKGROUND

1. Field of the Invention

The present invention relates generally to an improved personal communication device that can be incorporated into a plurality of accessories to suit a users preference.

2. Description of the Related Art

Long gone are the days of relying solely on paper business cards to swap contact information. In today's electronic environment, many people prefer to utilize personal communication devices capable of wirelessly communicating information such as pictures and contact information. These devices typically include cellular telephones or electronic data assistants which are highly expensive and often have a box-like shape making them awkward to carry and/or use. As a result, recent innovations have attempted to reduce the size of the devices so that they may be worn on or about the body of a user. For instance, U.S. Patent Publication No. 2003/0174049, to Beigel; and U.S. Pat. No. 6,285,757 to Carroll, the contents of each of which are incorporated herein by reference, include communication devices that can be worn on the wrist of a user.

However, these and other conventional devices continue to be difficult to operate, by requiring a user to perform several steps before data can be transferred. Moreover, these devices provide few, if any options for performing visual customization of the device in order to suit the particular likes and style of the user. As a result, users typically place these devices in pockets or utilize bulky carrying cases which can easily be lost or stolen. Additionally, when new designs become available, users are forced to replace the entire device in order to conform to the latest trends which is both costly and wasteful.

Accordingly, it would be beneficial to provide an improved personal communication device that is simple to operate and can adapt to a plurality of accessories in order to conform to the individual taste of a user.

### SUMMARY OF THE INVENTION

The present invention is directed to an interchangeable personal storage and communication device. One embodiment of the present invention can include a main body having a memory for storing data, a communication unit for communicating with at least one external device, and a display. The embodiment may further include a host apparatus that can be worn on or about a user into which the main body can be removably connected.

Another embodiment of the present invention can include a personal storage and communication device that includes the ability to track the location of the unit via a GPS transmitter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a frontal elevation of an interchangeable communication device that is useful for understanding the embodiments disclosed herein.

FIG. 2 is a high level block diagram representation of an embodiment of an interchangeable communication device.

FIG. 3 is a top view of one embodiment of the invention.

FIG. 4 is a top view of an alternate embodiment of the invention.

FIG. 5 is a top view of an alternate embodiment of the invention.

FIG. 6 is a top view of an alternate embodiment of the invention.

FIG. 7 is a top view of an alternate embodiment of the invention.

FIG. 8 is a flow chart illustrating a method of performing two way communication in accordance with the present invention.

FIG. 9 is a top view of an alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

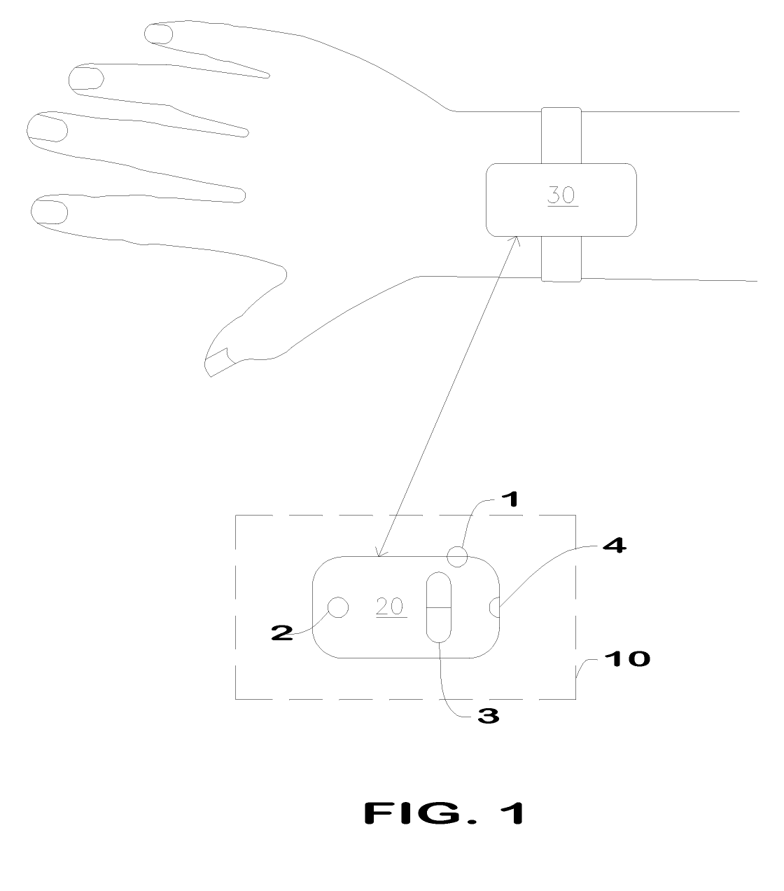

FIG. 1 illustrates one embodiment of an interchangeable communication device that is useful for understanding the embodiments disclosed herein. As illustrated, the Interchangeable Communication Device (ICD) 10 can include a interchangeable main body 1 which houses a visual display 2, a user interface 3, a communication port 4 and internal electronics 20.

According to this embodiment, main body 1 can be removably attached to a host device 30. As shown, host device 30 can be, for example, a bracelet that is worn about the arm of a user; however other designs are contemplated as will be discussed below in greater detail. In a preferred embodiment, main body 1 can be made of a sturdy plastic material to protect against impact and adverse weather conditions, although other materials are also contemplated.

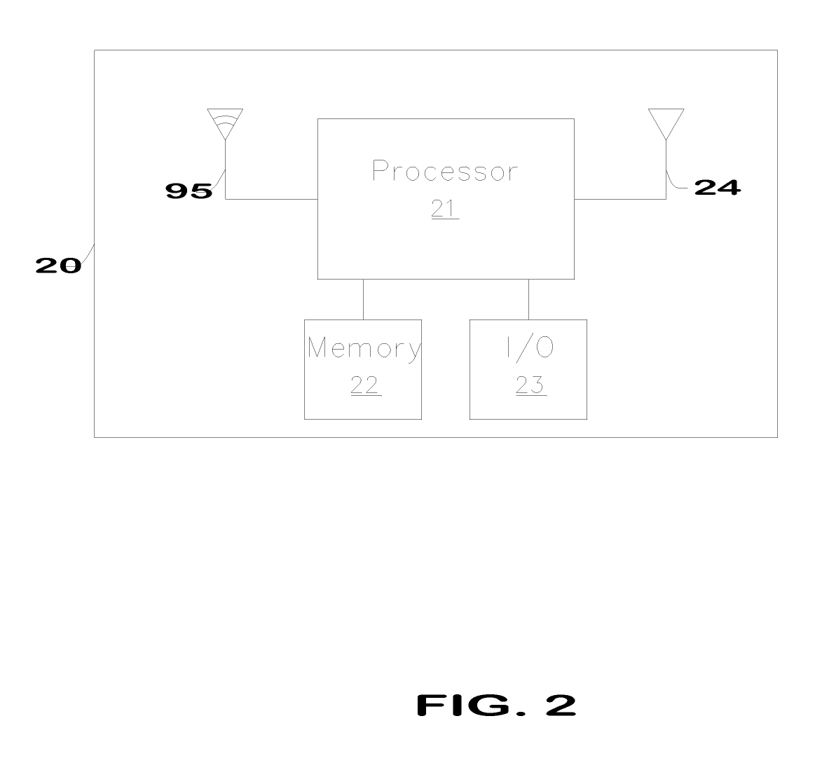

Visual display 2 can include, for example, a light emitting diode (LED) capable of shining a variety of colors in order to visually communicate with a user of the device. User interface 3, can include a button or other known switch which can activate the internal electronics when depressed by a user. Communication port 4 can preferably be positioned along a periphery of the main body and include an interface for receiving a communications cable in order to connect to an external device (not shown). In an alternative embodiment, communication port 4 can also be utilized to directly communicate with the host device 30. FIG. 2 illustrates an embodiment of the internal electronics 20 which can store information and communicate, both wirelessly and via a cable, with other devices. Internal electronics are shown for illustration purposes only, as additional known components for performing the identified functions are also contemplated. For instance, components for performing bidirectional wireless communications such as those described in U.S. Patent Publication No. 2009/0323771, to Zhen, the contents of which are incorporated herein by reference are also contemplated.

As shown, electronics 20, according to one embodiment can include a processor 21, memory element 22, an Input/Output component 23 and an antenna 24. In one embodiment, memory 22 can store data belonging to a user in addition to program code which can be accessed by processor 21 in order to operate the device 10. As would be known to one of skill in the art, memory 22 can include one or more physical memory devices for storing data such as, for example, random access memory or other non-persistent memory device(s) generally used during actual execution of the program code, a hard drive, or cache.

I/O port 23 can be connected to communications port 4 in order to communicate with external devices such as a personal computer, for example. As would be known to one of skill in the art, I/O port 23 can be configured to interface with a USB cable, HDMI, or virtually any other known means.

Antenna 24 can be adapted to perform wireless communication with virtually any kind of remote device, system or network. As such, antenna 24 can utilize any number of communication methodologies such as RF, IR, ultrasonic, laser, cellular, Bluetooth, optical, and other known means.

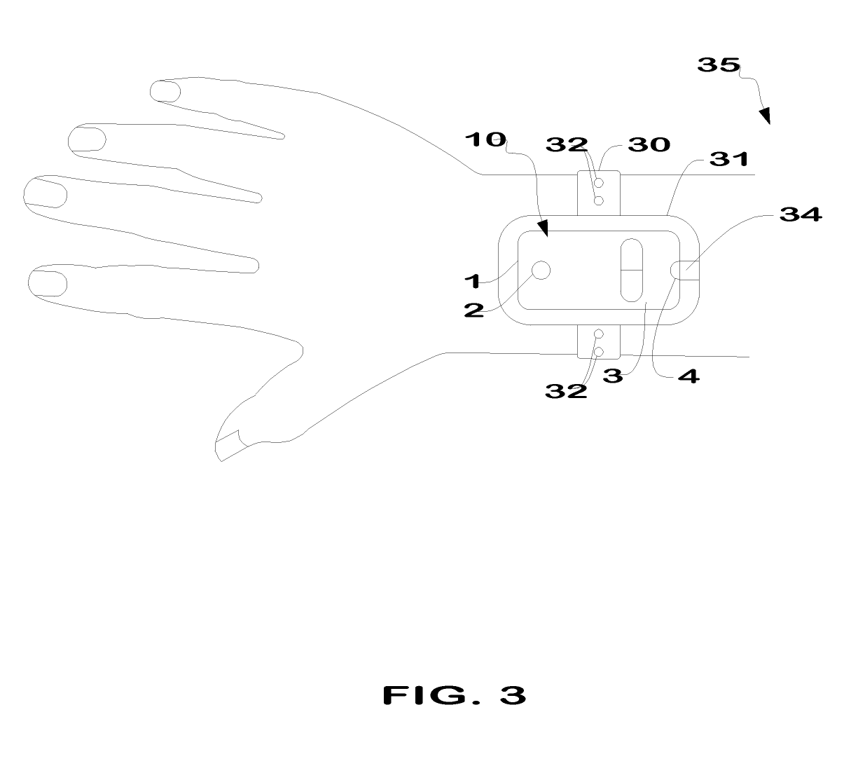

FIG. 3 illustrates one embodiment of a host device 30 that can receive the ICD 10 such that the ICD can be seamlessly absorbed into the look of the host device. In this manner, the combination of the host device 30 with the ICD can be considered a communications system 35 capable of communicating with external devices (not shown).

As shown, host device 30 can include a docking station 31 for securely positioning the ICD 10 and an I/O port 34 for communicating with the communication port 4 of the ICD. In another embodiment, host device 30 can further include additional features to enhance the usability of the ICD. For example, host device 30 can include one or more displays 32, such as, for example, an LED, LCD or other means capable of communicating information to the user in a manner similar to the visual display 2, described above. In this manner, the host device 30, when connected to the ICD 10 can extend the functionality and usefulness of the ICD by providing additional features to a user.

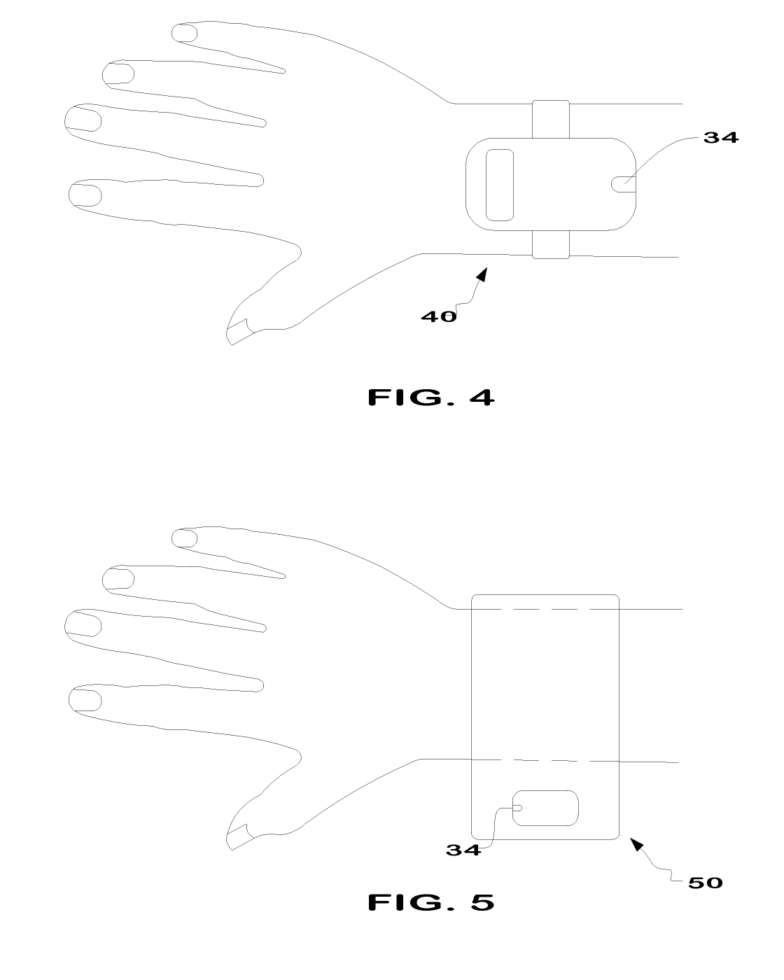

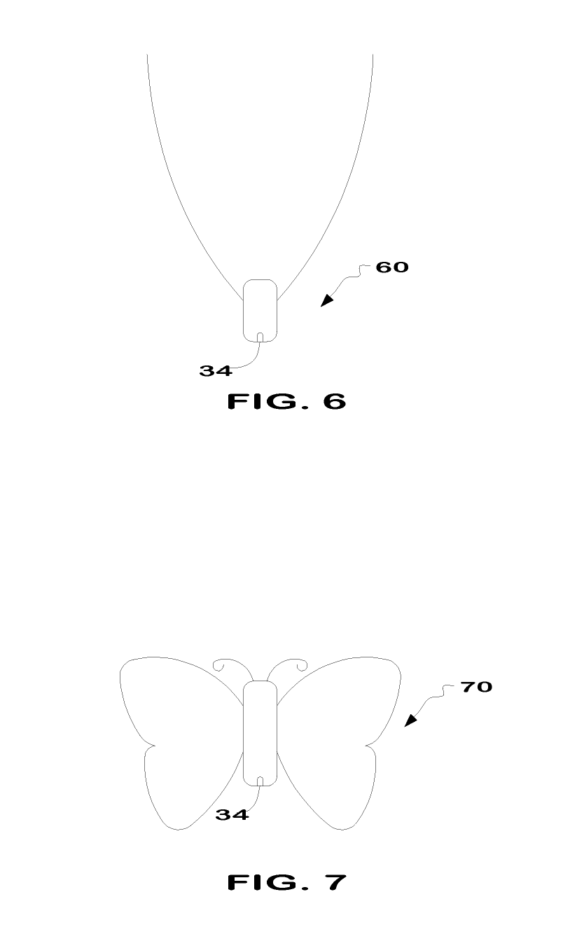

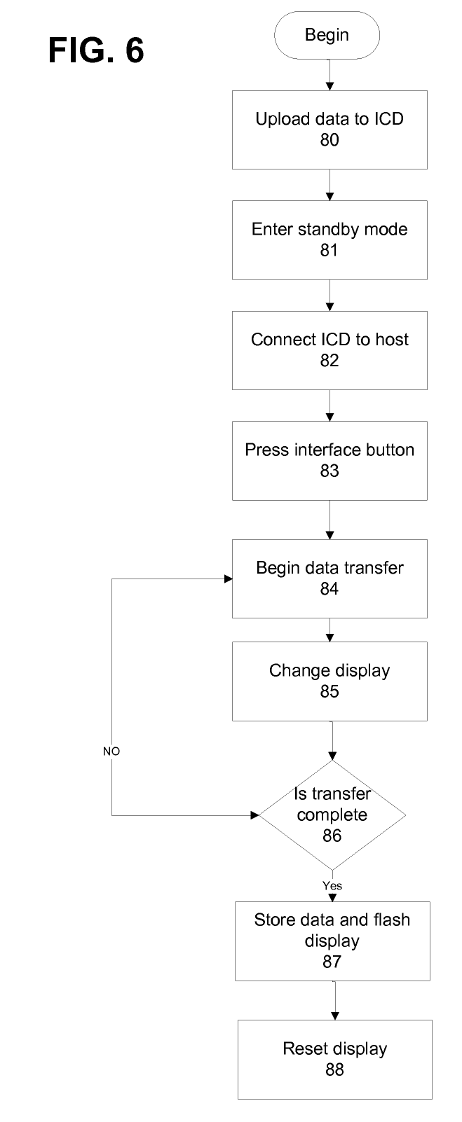

Although illustrated above with respect to a bracelet, the invention is not so limited, as the host device 30 can take a variety of different shapes to suit the particular likes or needs of a user as illustrated in FIGS. 4-7. For instance, alternate embodiments of host device 30 can include a watch 40, cufflink 50, pendant 60, and brooch 70, for example. As would be known to one of skill in the art, the above list is merely illustrative, as the host device can take virtually any shape and can include limitless possibilities when it comes to color, and designs which can be incorporated onto the host device.

By providing a plurality of design choices with respect to the host device 30, a user can pick and chose which host device they want to wear for any given occasion and simply insert the ICD 10 into that host. As such, a user can continually change the look and feel of the device, thus keeping up with current fashion trends while still utilizing their existing ICD thereby eliminating the expense and waste associated with purchasing new electronics every year.

In operation, the ICD 10 can easily send and receive data, such as contact information and/or multimedia data with other devices. In one embodiment, the ICD can perform two way communication with the press of a single button, as illustrated by the method of FIG. 8.

The method 800 can begin at step 80 where data, such as contact information, is transferred from a computer or other external device into the ICD via the communications port 4. However, the device is not limited to utilizing the communications port to import the data, as this may also be accomplished via the antenna 24.

In step 81, the device can go into standby mode. As such, in one embodiment, upon entering standby mode, the display can illuminate a predetermined color (blue, for example) in order to indicate that the memory contains the contact information and that the device is ready for use.

In step 82, a user can connect the ICD to a desired host device. In step 83, when the device comes into proximity with another ICD, the users of both devices can simultaneously press the interface button 3.

In step 84, the processor 21 can access the memory 22 and instruct the antenna 24 to begin sending and receiving the contact information.

In step 85, the processor can instruct the display 2 to notify the user that a data transfer is under way. For example, in a preferred embodiment, the display 2 can change color during the transfer.

In step 86, the processor can monitor the data transfer. Upon sensing the transfer is complete, the method can proceed to step 87, otherwise the method will return to step 84 to continue the transfer.

In step 87, the data can be stored in the memory and the processor can instruct the display 2 to notify the user that the data transfer is complete. For example, in a preferred embodiment, the display 2 can flash for a predetermined period of time (preferably 3 seconds) in order to notify the user that the data transfer is complete.

Finally, in step 88, the display can return to the original standby settings to indicate the device is ready for the next transfer.

In addition to being utilized by individuals, other uses are contemplated. For instance, the inventive concepts may be useful within the real estate industry. As such, an ICD can be utilized in combination with a real estate lock box in order to provide digital information (flyers, and pricing information, for example) about the property in question. As such, when activated by a realtor utilizing an ICD of their own, the devices can swap information in the manner described above.

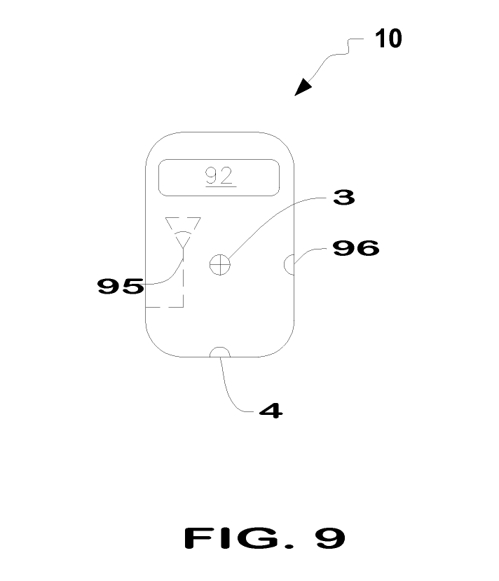

Although described above with respect to an LED display and single functionality, the invention is not so limited. For instance, FIG. 9 illustrates an alternate embodiment of an Interchangeable Communications Device 10 that can further include a dynamic display 92, a GPS locator 95 and a headphone jack 96.

The dynamic display 92 can include an LCD or other known screen technology including a touch screen system in which a user can visually access the contents of the device memory 22. In this manner, a user can easily select from multiple contact information, pictures, music or other data when communicating with other devices, systems and networks as described above.

Additionally, ICD 10 may be equipped with a GPS locator 95 (See FIG. 2) which can be used to locate the device, and (presumably) the user of the device. One example of such a system can be found in U.S. Pat. No. 6,243,039, to Elliot, the contents of which are incorporated herein by reference. Such a feature may be advantageous, for example, to parents who utilize the device 10 to store a child's home address and/or medical records in case they become lost. Finally, the ICD 10 may contain an optional headphone jack 96 in order to enable playback of multimedia files, thus enabling the device to be utilized as an MP3 player, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An interchangeable personal storage and communication device comprising:
a main body having a front side and a back side, said main body including
a processor,
a memory configured to store data,
a communication unit configured to communicate with at least one external device, and
a display; and
a host apparatus configured to be worn on or about a user, said host apparatus including an opening for receiving a portion of the main body,
wherein said main body is further configured to be removably connected to the host apparatus such that the front side of the main body is accessible to a user and the back of the main body is hidden.

2. The interchangeable storage and communication device of claim 1, wherein said communication unit is configured to wirelessly transmit and receive data in response to an instruction from the user.

3. The interchangeable storage and communication device of claim 1, wherein said communication unit is further configured to transmit and receive data via a communications cable.

4. The interchangeable storage and communication device of claim 1, wherein said host apparatus includes at least one of a watch, bracelet, cuff, bangle, cuff link, pendant and brooch.

5. The interchangeable storage and communication device of claim 1, wherein said host apparatus further comprises:
one or more LED devices configured to operate in response to an instruction from the processor.

6. The interchangeable storage and communication device of claim 1, further comprising a headphone jack.

7. The interchangeable storage and communication device of claim 1, further comprising a Global Positioning System (GPS) tracking system.

8. The interchangeable storage and communication device of claim 1, wherein said display is an LED device.

9. The interchangeable storage and communication device of claim 1, wherein said display is an LCD screen.

10. A method for transferring data using an interchangeable personal storage and communication device, said method comprising:
loading data into a memory;
displaying a notification to a user;
connecting a main body to a host apparatus;
detecting a proximity to a second device;
communicating with the second device in response to an input from the user;
displaying a second notification to the user.

11. The method for transferring data using an interchangeable personal storage and communication device of claim 10, wherein said communicating further comprises:
wirelessly communicating with the second device via at least one of an RF, IR, ultrasonic, laser, cellular, or Bluetooth signal.

12. An interchangeable personal storage and communication device comprising:
a main body having a front and a back side, said main body including
a memory,
means for communicating with at least one external device, and
means for visually communicating with a user; and
means for removably housing the main body.

13. The interchangeable storage and communication device of claim 11, further comprising:
means for tracking a position of the device.
